(19) United States
(12) Patent Application Publication
(10) Pub. No.: US 2012/0313463 A1
(43) Pub. Date: Dec. 13, 2012

(54) ROTOR OR STATOR EMBEDMENT

(75) Inventors: David James Howell, Newton (NZ); Andreas Hartmut Hatz, Helensville (NZ)

(73) Assignee: WELLINGTON DRIVE TECHNOLOGIES LIMITED, Auckland (NZ)

(21) Appl. No.: 13/574,119

(22) PCT Filed: Dec. 20, 2010
(86) PCT No.: PCT/NZ2010/000258

§ 371 Date: Aug. 29, 2012

(30) Foreign Application Priority Data
Jan. 20, 2010 (NZ) 582764

(51) Int. Cl. H02K 1/06; B29C 45/14

(52) U.S. Cl. 310/43; 264/261

(57) ABSTRACT

A rotor for a motor or generator is produced by placing separated magnets around the diameter of the potential rotor, placing separated segments of magnetic backing material behind the magnets, and embedding the whole in molding material in a mold in such a way that the segments thrust outwards against the magnets and the magnets thrust outwards against the mold during placement of the molding material.

### TECHNICAL FIELD

The invention generally relates to electrodynamic machines. More particularly the invention relates to the creation of a single piece electrodynamic rotor or stator.

### BACKGROUND ART

Articles such as permanent magnet rotors or stators for electrodynamic machines are known, and typically comprise one or more magnets mounted upon a hub or ring of soft magnetic material, these magnetically active components being retained concentric to a shaft or bearings. For best performance of the electrodynamic machine, it is desirable to achieve the best possible concentricity of the magnetic components. This allows the magnetic air gap to be reduced, and also minimises out-of-balance forces.

One known method of retaining the active components is embedment within a moulded polymeric material. This method has the advantage of low cost, but due to the clearances necessary to insert the active components into the embedding fixture in production, it is difficult to achieve good concentricity and minimal airgap. This can be overcome to some extent by either using tight component tolerances, or by locating the components rigidly with respect to each other before assembly into the fixture.

In the first case, additional component manufacturing cost is incurred, and assembly made more difficult, while in the second case the level of security of retention required is often similar to that required to assemble a non-embedded rotor or stator, making the embedment step redundant.

When broad component tolerances are used, the clearances required for insertion can also result in thin skins of embedment material forming between the magnet surfaces and the fixture, which potentially lead to reliability problems in service. This can be avoided by deliberately introducing a skin of embedment material which is sufficiently thick as to be structurally secure. However this increases the magnetic air gap, reducing performance of the electrodynamic machine.

### PRIOR PATENTS

U.S. Pat. No. 4,973,872—This patent discloses a shaft mounted rotor with permanent magnets and a rotor core and a plastic molded sleeve encapsulating the rotor assembly securing it in position. The rotor assembly is held in place entirely by the encapsulating plastic molded sleeve. The presence of this sleeve increases the magnetic airgap, reducing motor efficiency. Additionally, structural failure in the encapsulating material (e.g.: cracks, etc) can lead to complete failure of the rotor over a period of time. Furthermore difficulties arise in the manufacturing process since precise positioning of the rotor components prior to injection molding is hard to achieve. Therefore the rotors may have concentricity issues and a high rejection rate at production.

U.S. Pat. No. 7,067,944—This patent discloses a motor having a stator assembly, wherein the stator assembly is encapsulated in injection molded thermoplastic material. Similarly to U.S. Pat. No. 4,973,872, the stator assembly is firmly held together entirely by the encapsulating material. Therefore it is subject to the same structural stability issues and it is also difficult to hold the stator assembly in place prior to the injection molding process.

U.S. Pat. No. 7,019,422 & U.S. Pat. No. 6,892,439—Both patents disclose a stator of a motor having multiple conductors that create a plurality of magnetic fields when electrical current is conducted through the conductors. The stator has a pair of opposing end surfaces in contact with each other forming a toroidal core. A monolithic body of phase change material encapsulates the stator assembly firmly in place. Hence these patents exhibit the same disadvantages as U.S. Pat. No. 7,067,944 where difficulties in the assembling process results in concentricity issues.

Therefore it can be seen that none of the prior art patents provide a suitable solution to embedding a rotor or stator of a motor in polymeric material while achieving good concentricity of the active components at low cost. Furthermore the prior art depends entirely on the structural strength of the embedding material to hold all components in place and hence failure of the encapsulant can lead to complete failure of the motor.

### OBJECT

It is an object of the invention therefore, to provide a method of embedding rotor or stator components in a manner which allows embedment without unduly strict requirements for component placement yet provides a balanced assembly and minimised air gap.

The present invention provides a solution to these and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a rotor or stator for an electrodynamic machine, the rotor or stator having a substantially circularly arranged series of magnets, a substantially circularly arranged series of items of magnetic material in loose contact with the magnets, the contact between the items of magnetic material and the magnets being such that during embedment in a viscous plastic material the flow of plastic material will not substantially penetrate between the magnets and the items of magnetic material across the area of contact during embedment.

Preferably the plastic material is a thermoplastic injected into a mold containing the items of magnetic material and the magnets, the magnets and items of magnetic material being below the freezing temperature of the thermoplastic material.

Preferably the rotor components can dynamically move during embedment to accommodate differences in component tolerances.

Preferably the contact between the magnets and a mold wall locating the limits of magnet movement during embedment is such that the flow of plastic material does not substantially penetrate between the magnet and the mold wall leaving at least a portion of the magnet uncovered by the embedment.

Preferably the items of magnetic material form the sole rotor core or sole stator core of the dynamoelectric machine.

Preferably there is the same number of magnets and of items of magnetic material.

Preferably the gap between items of magnetic material falls substantially midway along the periphery of a magnet.

Preferably the magnets and items of magnetic material are supported upon a carrier facilitating the assembly of the arrangement and placement of the arrangement into a mold.

Preferably the carrier locates the magnets and items of magnetic material sufficiently loosely as to allow easy placement of the parts into the carrier and of the assembly into the mold.

Preferably the magnets have at least two outer bevelled edges accommodating the carrier supports.

Preferably the items of magnetic material are arcs of steel plate.

In an alternative embodiment the invention consists in a method of embedding an electrodynamic machine rotor or stator within a plastic material by:
providing a substantially circularly arranged series of magnets,
providing a substantially circularly arranged series of items of magnetic material arranged in loose contact with the magnets, the ends of the items of magnetic material being aligned such as to be in regions of low magnetic flux;
providing a mold in which the series of magnets and the series of items of magnetic material are concentrically arranged, movement of the magnets being limited by abutment with a mold wall;
injecting plastic material under pressure against the items of magnetic material and thence against the magnets and the mold wall;
the injection pressure against the items of magnetic material dynamically maintaining them substantially in contact with the magnets and maintaining the magnets substantially in contact with the mold wall during injection and setting of the plastic injection material.

In a further embodiment the invention consists in a non-magnetic carrier for assembling the components of an electrodynamic machine, the carrier supporting an outer circular ring of separated magnets, an inner circular ring of separated magnetic material items, and an electrodynamic machine axle, the carrier having outer supports adapted to carry a ring of magnets, each magnet being maintained separated from those adjacent, median supports adapted to carry a ring of items of magnetic material each separated from those adjacent, and inner supports adapted to locate an electrodynamic machine axle centrally of the magnetic material items and the magnets.

Preferably the carrier can be assembled in an injection mold with the magnets, magnetic items and axle.

Preferably the mold is injected with a material miscible with the carrier.

Preferably the mold injection pattern maintains the magnetic material items biased against the magnets during injection and the mold injection temperature does not render the carrier liquid.

In another embodiment the invention resides in a motor having a rotor and stator, at least one or both of the rotor or the stator having a substantially circularly arranged series of magnets, a substantially circularly arranged series of items of magnetic material in loose contact with the magnets, the contact between the items of magnetic material and the magnets during assembly being such that during embedment in a plastic material the flow of plastic material will not substantially penetrate between the magnets and the items of magnetic material across the area of contact during embedment.

These and other features of as well as advantages which characterise the present invention will be apparent upon reading of the following detailed description and review of the associated drawings.

### BRIEF DESCRIPTION OF THE DRAWINGS

FIG. 1 is a general perspective view of a dynamoelectric machine rotor according to the invention

FIG. 2 is a side view of the rotor according to FIG. 1.

FIG. 3 is an end view of the base of the rotor of FIG. 1.

FIG. 4 is a cross sectional view of the rotor of FIG. 2 along the line A-A.

FIG. 5 is a cross sectional view of the rotor of FIG. 1 along the line C-C of FIG. 4.

FIG. 6 is a perspective view of the carrier which holds the rotor components for assembly.

FIG. 7 is the carrier of FIG. 7 with some of the components mounted.

FIG. 8 is the carrier of FIG. 7 with all components mounted located within an injection mold base.

FIG. 9 is a view of the completed rotor from an angle which differs from FIG. 1.

FIG. 10 is a view of a section of a dynamoelectric machine of similar construction showing the magnetic flux.

FIG. 11 is a view as in FIG. 9 in which the injection flow pattern is shown.

FIG. 12′ shows a perspective view of the components of a carrierless machine

FIG. 13 shows FIG. 12 with some components removed for clarity

FIG. 14 shows a cross-sectional view of the embedded machine of FIG. 15.

FIG. 15 is a side view of the embedded machine.

FIG. 16 shows an end view of the embedded machine.

FIGS. 17 and 18 show differing perspective views of the carrierless machine.

### DESCRIPTION OF THE INVENTION

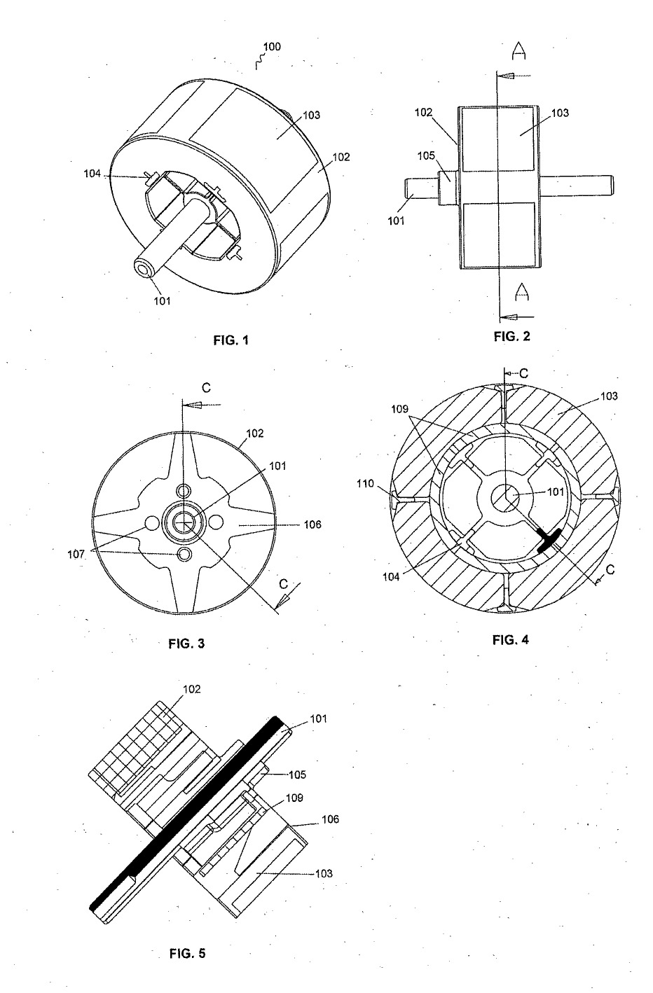

Referring now to FIG. 1 a completed dynamoelectric machine rotor 100 is shown. The rotor includes an axle 101, moulding material 102 and magnets 103 spaced around the rotor. Also visible are claw parts 104 of a carrier 108 which located parts of the rotor before molding and which are now embedded within the molding material.

FIG. 2 shows a side view of the rotor of FIG. 1 showing axle 101, molding material 102 and magnets 103. It should be noted that in the construction shown no circumferential reinforcement is placed outside the magnets.

FIG. 3 shows a base view of the rotor of FIG. 1 in which a carrier base 106 having fixing holes 107 is embedded within moulding material 102. Axle 101 is centrally located by the carrier.

FIG. 4 shows a section along line A-A of FIG. 2 prior to the molding material being placed. Four magnets 103 can be seen, as can four arcs of steel 109 which act as flux links between the inner faces of the magnets 103. Axle 101 is located within the carrier and claws 104 act to hold the arcs 109 outwards while retainers 110 act to hold the magnets 103 inwards. The rotor components are thus retained in place ready for molding.

FIG. 5 shows a cross section along C-C of FIG. 4 once the molding material is in place. Axle 101 is now embedded within a boss 105 and the carrier, arcs 109 and magnets 103 are now fixed within the molding material 102.

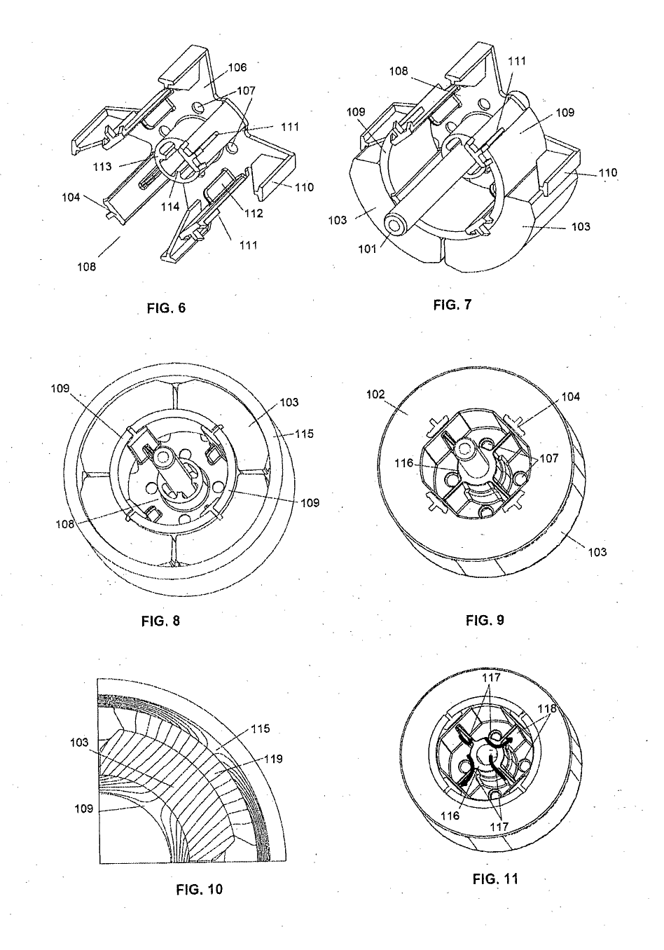

FIG. 6 shows a perspective view of one form of carrier 108 fore retaining the components in place for molding in which the carrier 108 has a base 106, holes 107 for later fixing of the rotor, a boss 113 for retaining the axle in place, the axle bearing against locating rails 114. Claws 104 are backed with reinforcement 112 and have spacers 111 which act to space apart the arcs of steel 109. Retainers 110 at the outer periphery of the carrier 108 space the magnets 103 apart and hold these in place before molding takes place.

FIG. 7 shows two magnets 103 and three steel arcs 109 in place on carrier 108 and illustrates how the arcs bridge the gap between the magnets but are separated from each other by spacers 111 on claws 104. The magnets are similarly spaced apart by the buttress on retainers 110.

FIG. 8 shows a carrier 108, complete with all components placed in the base of an injection mold 115. The magnets 103 are a close fit against the walls of the mold, and the arcs of steel 109 are a close fit against the rear of the magnets 103. As located in the mold 115 the arcs of steel are in loose contact with the magnets and the magnets are in loose contact with the outer wall of the mold, that is, the components are restrained substantially in position but are relatively movable. When the mold top is fitted the injected plastic material moves from the centre of the mold outwards as shown in FIG. 11, exerting force against the arcs of steel sufficient to force them into firm contact with the magnets, preventing the injected material from intruding between the steel and the magnets 103. Similarly the injected material and the force of the steel arcs 109 forces the magnets against the inner wall of the mold, preventing the injected material from intruding between the outer face of the magnet and the mold wall. In its path outwards the injected material flows through the gaps between the steel arcs 109 and between the magnets 103 to ensure that the whole is solidly bonded. The pressure which the parts are under during embedment ensures that the gap between the arcs 109 and the magnets 103 is minimal, improving efficiency, and that the magnets are solidly against the mold wall ensuring concentricity.

This dynamic movement allows more relaxed component tolerances, since components will always move towards the outer wall of the mold in such a way as to take up any radial tolerances. Similarly the location of the breaks between the arcs 109 at a point of minimal flux means that these do not have to be unduly precisely dimensioned.

The magnets are preferably bevelled on at least two of the outer edges, the bevels forming an included arc of more than 90 degrees, to allow the molding material to provide a strength member tending to retain the magnet against the centripetal forces acting in operation of the machine and bond to the outer edge of the magnet.

While the version shown provides magnets which are proportioned to fit so closely to the mold that embedment material cannot intrude between the two the mold or magnets may be provided with protrusions to space the magnets from the mold wall and allow embedment material to partially or completely cover the magnet's outer surface. This can provide more strength and can also reduce magnetorestrictive sound effects.

FIG. 9 shows the embedment assembly with mounting holes 107, axle surround 116 and no embedment material over magnets 103.

The carrier material and the plastic injection material may be the same, for instance 30% glass filled nylon, since the use of the same material encourages welding of the plastic parts, and prevents thermal expansion effects and possible fatiguing at the interface. Typically the temperature of the injection material is sufficient to melt the surface of the carrier and bond to it, but insufficient to allow it to melt before the steel and magnets are forced against the mold wall. The gaps between the steel arcs and between the magnets are typically about 0.5 mm, providing sufficient room to allow easy insertion of the parts but insufficient to allow misalignment when placed in the mold. The carrier 108 is preferably sufficiently flexible to allow movement of the components while still maintaining them in loose contact.

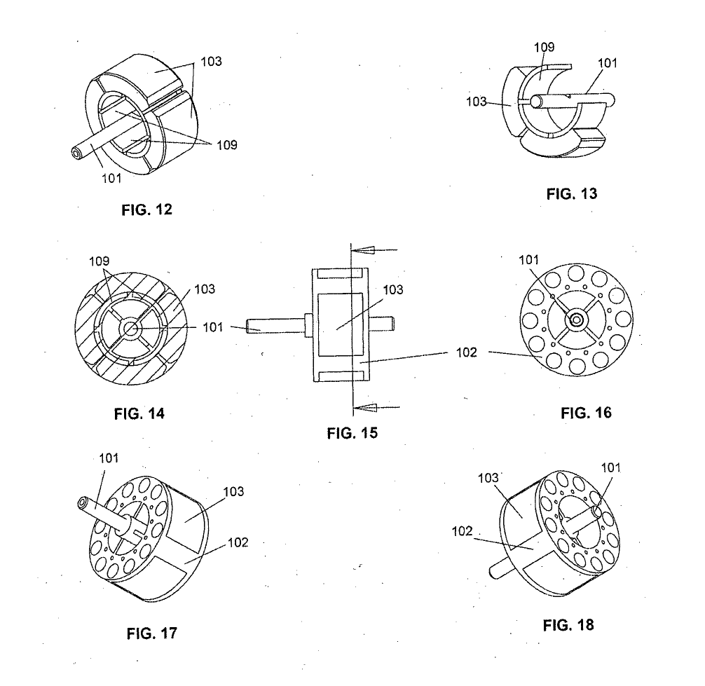

FIGS. 12 to 18 show the components of a motor version without a carrier for the magnets and steel arcs in which an axle 101, magnets 103 and steel arcs 109 are placed directly within a mold, the mold being oriented with, the rotational axis vertical, such that the inserted parts are retained in place by gravity. Pins in the mold walls (not shown) bear against the steel arcs and magnets to loosely locate them in the correct position while allowing enough clearance to facilitate easy loading of the parts. Again the injection of the molding material 102 urges the steel arcs outwards against the magnets and the magnets outwards against the cylindrical mold walls in such manner that the injected melt cannot enter between the arcs 109 and the magnets 103 nor between the magnets and the cylindrical mold walls, providing good control of the position of the inserts in the finished part. Such a version is suited to embedment using a “vertical axis” type molding machine, as machines of this type provide the necessary orientation of the mold.

Other materials and spacing may be used so long as the molding method provides a pressure tending to move the steel arcs 109 and magnets 103 against the outer mold wall during molding.

During injection of the viscous embedding material side edges of the melt contact the mold walls and freeze virtually instantaneously to a limited depth and the very viscous melt front contacts the steel or magnet inserts and undergoes a rapid increase in viscosity because of the lower temperature of these components. This results in freezing of the melt at the components as the components are forced together by the injection pressure and a consequent inability of the material to enter small crevices or gaps between the steel and magnets or between the magnets and the cylindrical mold wall. The width of the crevice which cannot be entered will vary with the viscosity of the melt material, the temperature of the melt, the temperature of the components and the pressure of the melt, much as the provision of air vents for the escape of air is known which do not allow flow of embedding material. As long as the magnets and other components are at a temperature lower than the melt freezing point and do not warm above that temperature during injection the melt will not enter small gaps. However the injection temperature and mold design must be such that the injection material will embed the components sufficiently to maintain them in place under normal working stresses.

The use of this method allows the creation of a molded rotor in which there is no reinforcement required outside the rotor, the configuration and spacing of the magnets and the backing steel arcs being sufficient in conjunction with the mold material to provide a cohesive unitary construction which will withstand normal working stresses. Since the final radial position of the magnets and backing steel arcs is determined by the injection mold, which can be a precision manufactured part, the method also provides good concentricity of the components and thus good balance of the finished rotor.

The rationale for using steel arcs is shown in FIG. 10 which shows the flux paths for a rotor such as that of FIG. 1 in which a steel cylinder 109 has mounted on it magnets such as 103 with an air gap 119 to a back iron 115. At the centre line of the magnet the flux is typically low in the steel cylinder and substantially vertical, which means that it, is possible to make a gap in the cylinder wall without materially affecting the flux in either the magnets, the back iron or the steel cylinder.

It is not essential that steel arcs be used. Any magnetic material with the required mechanical strength and magnetic characteristics, such as iron laminate is usable, however steel provides a cheap material, and the arcs can be easily stamped from a flat sheet.

FIG. 11 shows the same view of the assembly as FIG. 9 but shows the paths 117 taken by the injected plastic material from mold runners (not shown) at top of the axle surround 116 into webs 118 leading to the carrier claws so that these and the arcs they are carrying are pressed against the magnets which it turn press against the outer wall of the mold.

While the description relates to a rotor with external axial magnets the same construction is adaptable to a disk rotor with radially external magnets, to a permanent magnet stator variant such as is typically used in brushed DC motors, or to a stator or rotor in which the magnets are replaced by coils backed by steel arcs. The coil cores in such a case may be laminated steel or sintered ferromagnetic material, provided that the molding material is placed in such a way as to dispense with the use of reinforcement outside the coils which adds to the cost and constructional difficulties.

Similarly the construction is adaptable to a construction in which the main components are centrally located and injection and movement is towards the centre rather than towards the outside or to a construction in which the components are of a disk machine and movement of the injection material is axial in one or both directions to force the components to the side of the disk.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the rotor may vary dependent on the particular application for which it is used without variation in the spirit and scope of the present invention.

In addition, although the preferred embodiments described herein are directed to rotors for use in an electrodynamic machine, it will be appreciated by those skilled in the art that variations and modifications are possible within the scope of the appended claims.

### INDUSTRIAL APPLICABILITY

The rotor or stator of the invention is used in the manufacture of electrodynamic machines such as motors and generators which are employed it the electrical industry. The present invention is therefore industrially applicable.

1. A rotor or stator for an electrodynamic machine, the rotor or stator having a substantially circularly arranged series of magnets, a substantially circularly arranged series of items of magnetic material in contact with the magnets, the contact between the items of magnetic material and the magnets being such that during embedment of the rotor and stator in a plastic material the flow of plastic material will not substantially penetrate between the magnets and the items of magnetic material across the area of contact during embedment.

2. A rotor or stator as claimed in claim 1, wherein the plastic material is a thermoplastic injected into a mold containing the items of magnetic material and the magnets, the magnets and items of magnetic material being below the freezing temperature of the thermoplastic material.

3. A rotor or stator as claimed in claim 1, wherein the rotor or stator, components can dynamically move during embedment to accommodate differences in component tolerances.

4. A rotor or stator as claimed in claim 1, wherein the contact between the magnets and a mold wall locating the limits of magnet movement during embedment is such that the flow of plastic material does not substantially penetrate between the magnet and the mold wall leaving at least a portion of the magnet uncovered by the embedment material.

5. A rotor or stator as claimed in claim 1, wherein the items of magnetic material form the sole rotor core or sole stator core of the dynamoelectric machine.

6. A rotor or stator as claimed in claim 1, wherein there is the same number of magnets and of items of magnetic material.

7. A rotor or stator as claimed in claim 1, wherein at least one gap between the items of magnetic material falls substantially midway along a periphery of a magnet.

8. A rotor or stator as claimed in claim 1, wherein the magnets and items of magnetic material are supported upon a carrier facilitating the assembly of the circularly arrange series of magnets and the items of magnetic material and placement of the circularly arranged magnets and the items of magnetic material into a mold.

9. A rotor or stator as claimed in claim 1, wherein the carrier locates the magnets and items of magnetic material sufficiently loosely as to allow easy placement of the parts into the carrier and of the assembly into the mold.

10. A rotor or stator as claimed in claim 1, wherein the magnets have at least two outer bevelled edges accommodating the carrier supports.

11. A rotor or stator as claimed in claim 1, wherein the items of magnetic material are arcs of steel plate.

12. A method of embedding an electrodynamic machine rotor or stator within a plastic material by:
a. providing a substantially circularly arranged series of magnets,
b. providing a substantially circularly arranged series of items of magnetic material arranged in loose contact with the magnets, the ends of the items of magnetic material being aligned such as to be in regions of low magnetic flux;
c. providing a mold in which the series of magnets and the series of items of magnetic material are concentrically arranged, movement of the magnets being limited by abutment with a mold wall;
d. injecting plastic material under pressure against the items of magnetic material and thence against the magnets and the mold wall;
e. the injection pressure against the items of magnetic material dynamically maintaining them substantially in contact with the magnets and maintaining the magnets substantially in contact with the mold wall during injection and setting of the plastic injection material.

13. A non-magnetic carrier for assembling the components of an electrodynamic machine, the carrier supporting an outer circular ring of separated magnets, an inner circular ring of separated magnetic material items, and an electrodynamic machine axle, the carrier having outer supports adapted to carry the ring of magnets, each magnet being maintained separated from those adjacent, median supports adapted to carry the ring of items of magnetic material each separated from those adjacent, and inner supports adapted to locate the electrodynamic machine axle centrally of the magnetic material items and the magnets.

14. A non-magnetic carrier as claimed in claim 13, wherein the carrier can be assembled in an injection mold with the magnets, magnetic items and axle.

15. A non-magnetic carrier as claimed in claim 13, wherein the mold is injected with a material miscible with the carrier.

16. A non-magnetic carrier as claimed in claim 13, wherein the mold injection pattern maintains the magnetic material items biased against the magnets during injection and the mold injection temperature does not render the carrier liquid.

17. A motor having a rotor and stator, at least one or both the rotor or the stator having a substantially circularly arranged series of magnets, a substantially circularly arranged series of items of magnetic material in loose contact with the magnets, the contact between the items of magnetic material and the magnets being such that during embedment of the motor rotor or stator in a plastic material the flow of plastic material will not substantially penetrate between the magnets and the items of magnetic material across the area of contact between the two during embedment.
